(19) United States
(12) Patent Application Publication
(10) Pub. No.: US 2026/0210594 A1
(43) Pub. Date: Jul. 23, 2026

(54) HEAT PUMP SYSTEM HAVING A SEPARATOR TO MITIGATE REFRIGERANT MALDISTRIBUTION IN A HEAT EXCHANGER

(71) Applicant: Hanon Systems, Daejeon (KR)

(72) Inventors: Minwoong Kang, Novi, MI (US); Evangelos S. Papoulis, Northville, MI (US); Guglielmo Abate, Canton, MI (US); Jongyeong Byun, Rochester Hills, MI (US); Jim Tasiopoulos, West Bloomfield, MI (US)

(21) Appl. No.: 19/442,008

(22) Filed: Jan. 7, 2026

Related U.S. Application Data
(60) Provisional application No. 63/748,218, filed on Jan. 22, 2025.

(51) Int. Cl. F25B 30/02

(52) U.S. Cl. CPC F25B 30/02

(57) ABSTRACT

A refrigerant circuit for a heat pump system and a method of operating the same are disclosed. The refrigerant circuit comprises a vapor injection compressor, one or more heat exchangers in fluid communication with the compressor, a liquid-gas separator, and one or more expansion elements. The heat pump system is configured to dynamically switch between a non-vapor injection mode and a vapor injection mode depending on operational conditions.

### CROSS-REFERENCE TO RELATED APPLICATION

This application claims the benefit of U.S. Provisional Patent Application Ser. No. 63/748,218, filed Jan. 22, 2025, the entirety of which is herein incorporated by reference.

### FIELD

The invention relates to a thermal management system, and more particularly, to a heat pump system of a thermal management system having an improved refrigerant circuit to mitigate maldistribution in a heat exchanger.

### BACKGROUND

A thermal management system in a vehicle may utilize a heat pump system to manage the temperature of various components of the vehicle and/or to heat or cool the air delivered to the passenger cabin of the vehicle. The heat pump system is circulated by a refrigerant and includes at least a compressor, a first heat exchanger acting as a condenser, an expansion element, and a second heat exchanger acting as a chiller (or evaporator). The compressor of the system may be operated to increase the temperature of the refrigerant to supply heat to the downstream condenser, which is in turn placed in heat exchange relationship with air delivered to the passenger cabin. The heating capacity of the cabin condenser is therefore dependent on the temperature of the refrigerant entering the cabin condenser following compression within the compressor.

FIG. 1 illustrates a conventional heat pump system using a vapor injection module and including a compressor, a condenser, an internal heat exchanger, a first expansion valve, a second expansion valve, a separator, an external heat exchanger, a third expansion valve, an evaporator, a fourth expansion valve, a chiller, and an accumulator. The compressor suctions the refrigerant, compresses the refrigerant into a high-temperature, high-pressure gaseous refrigerant, and then discharges the refrigerant to the condenser. The internal heat exchanger, together with the evaporator, may be disposed in a heating, ventilation, and air-conditioning (HVAC) case of the vehicle and heat the interior of the vehicle. The condenser may condense the compressed refrigerant. The refrigerant condensed by the condenser flows through a first fluid line and is supplied to the vapor injection module.

The first expansion valve may block the flow of the condensed refrigerant or expand the condensed refrigerant and transmit the expanded refrigerant to the separator. The first expansion valve is disposed in a second fluid line that connects the first fluid line and the separator. The second expansion valve may be connected to the separator in parallel with the first expansion valve, allowing the refrigerant to pass therethrough or expand the refrigerant, and discharge the refrigerant to the external heat exchanger. The second expansion valve may be disposed in a third fluid line that connects the first fluid line and the separator. The second and third fluid lines are connected to each other in parallel. The third expansion valve and the fourth expansion valve may perform expansion, communication, and blocking functions according to the respective modes. In other words, the respective expansion valves may perform three primary functions of expanding the refrigerant, allowing the refrigerant to pass without being expanded, and blocking the refrigerant.

The separator may separate the refrigerant having passed through the first expansion valve into the gaseous refrigerant and the liquid refrigerant and move the liquid refrigerant of the separated refrigerant to the second expansion means, and the gaseous refrigerant may be introduced into the compressor. During a non-vapor injection mode of the heat pump system of FIG. 1, the separator is bypassed, or both vapor and liquid refrigerant flow to the chiller. One disadvantage of such heat pump system and method of operation is that maldistribution occurs within the chiller under low flow conditions due to different properties of the two phases (vapor and liquid) of the refrigerant. In such cases, the performance of the chiller decreases significantly.

Accordingly, it would therefore be desirable to provide a heat pump system having an improved refrigerant circuit that mitigates maldistribution of the refrigerant within a heat exchanger to improve performance and efficiency of the system.

### SUMMARY

In concordance and agreement with the present disclosure, a heat pump system having an improved refrigerant circuit that mitigates maldistribution of the refrigerant within a heat exchanger to improve performance and efficiency of the system, has been newly designed.

In one embodiment, a heat pump system, comprises: a compressor configured to compress a refrigerant flow in the heat pump system; one or more heat exchangers in fluid communication with the compressor; a plurality of expansion elements in fluid communication with the heat exchangers, each of the expansion elements selectively positionable between a closed position, an open position, and one or more intermediate positions between the closed and open positions; a separator disposed downstream of one of the expansion elements relative to the refrigerant flow through the heat pump system and upstream of another one of the expansion elements relative to the refrigerant flow through the heat pump system, the separator configured to separate the refrigerant flow into a vapor refrigerant flow and a liquid refrigerant flow; and a flow control member disposed downstream of the separator relative to the refrigerant flow through the heat pump system, the flow control member selectively positionable between a first position and a second position, wherein the flow control member, in the first position, is configured to direct the vapor refrigerant flow to an injection side of the compressor when the heat pump system operates in a vapor injection mode, and wherein the flow control member, in the second position, is configured to direct the vapor refrigerant flow to a suction side of the compressor when the heat pump system operates in a non-vapor injection mode.

In another embodiment, a heat pump system, comprises: a compressor configured to compress a refrigerant flow in the heat pump system; a first heat exchanger disposed downstream of the compressor relative to the refrigerant flow through the heat pump system; a first expansion element disposed downstream of the first heat exchanger relative to the refrigerant flow through the heat pump system, the first expansion element selectively positionable between a closed position, an open position, and one or more intermediate positions between the closed and open positions; a separator disposed downstream of the first expansion element relative to the refrigerant flow through the heat pump system and configured to separate the refrigerant flow into a vapor refrigerant flow and a liquid refrigerant flow; a second expansion element disposed downstream of the separator relative to the refrigerant flow through the heat pump system, the second expansion element selectively positionable between a closed position, an open position, and one or more intermediate positions between the closed and open positions; a second heat exchanger disposed downstream of the second expansion element relative to the refrigerant flow through the heat pump system; and a flow control member disposed downstream of the separator relative to the refrigerant flow through the heat pump system, wherein the flow control member is selectively positionable to switch the heat pump system between a vapor injection mode and a non-vapor injection mode based on operational conditions of the heat pump system.

In yet another embodiment, a method of operating a heat pump system, comprises: providing a heat pump system including: a compressor configured to compress a refrigerant flow; one or more heat exchangers in fluid communication with the compressor; one or more expansion elements in fluid communication with the heat exchangers, each of the expansion elements selectively positionable between a closed position, an open position, and one or more intermediate positions between the closed and open positions; a separator configured to separate the refrigerant flow into a vapor refrigerant flow and a liquid refrigerant flow; and a flow control member selectively positionable between a first position and a second position; and dynamically controlling a mode of operation of the heat pump system between a vapor injection mode and a non-vapor injection mode by selectively positioning the flow control member based on operational conditions of the heat pump system.

As aspects of some embodiments, the first heat exchanger is configured to perform as a condenser.

As aspects of some embodiments, the second heat exchanger is configured to perform as a chiller or an evaporator.

As aspects of some embodiments, the first expansion element is in a desired one of the intermediate positions when the heat pump system is in the non-vapor injection mode.

As aspects of some embodiments, the first expansion element is in a desired one of the intermediate positions when the heat pump system is in the vapor injection mode.

As aspects of some embodiments, the second expansion element is in a fully open position when the heat pump system is in the non-vapor injection mode.

As aspects of some embodiments, the second expansion element is in a desired one of the intermediate positions when the heat pump system is in the vapor injection mode.

As aspects of some embodiments, the separator is in fluid communication with an injection side and a suction side of the compressor.

As aspects of some embodiments, the flow control member, in the first position, is configured to direct the vapor refrigerant flow to an injection side of the compressor when the heat pump system operates in the vapor injection mode.

As aspects of some embodiments, the flow control member, in the second position, is configured to direct the vapor refrigerant flow to a suction side of the compressor when the heat pump system operates in the non-vapor injection mode.

As aspects of some embodiments, the method further comprises sensing a speed of the compressor to determine a sensed compressor speed.

As aspects of some embodiments, the method further comprises comparing the sensed compressor speed to a first threshold speed for a predetermined duration.

As aspects of some embodiments, the first threshold speed is calibratable.

As aspects of some embodiments, the mode of operation of the heat pump system is switched from the non-vapor injection mode to the vapor injection mode when the sensed compressor speed is greater than the first threshold speed for the predetermined duration.

As aspects of some embodiments, the method further comprises comparing the sensed compressor speed to a second threshold speed for a predetermined duration.

As aspects of some embodiments, the second threshold speed is calibratable.

As aspects of some embodiments, the mode of operation of the heat pump system is switched from the vapor injection mode to the non-vapor injection mode when the sensed compressor speed is less than the second threshold speed for the predetermined duration.

### BRIEF DESCRIPTION OF THE DRAWINGS

The above, as well as other objects and advantages of the invention, will become readily apparent to those skilled in the art from reading the following detailed description of an embodiment of the invention when considered in the light of the accompanying drawing which:

FIG. 1 is a schematic flow diagram of a conventional heat pump system;

FIG. 2 is a schematic flow diagram of a refrigerant circuit of a heat pump system according to an embodiment of the present disclosure, wherein a vapor injection mode of the heat pump system is shown;

FIG. 3 is a schematic flow diagram of the refrigerant circuit of FIG. 2, wherein a non-vapor injection mode of the heat pump system is shown; and

FIG. 4 is a flow chart illustrating a method of operation of the heat pump system of FIGS. 2 and 3.

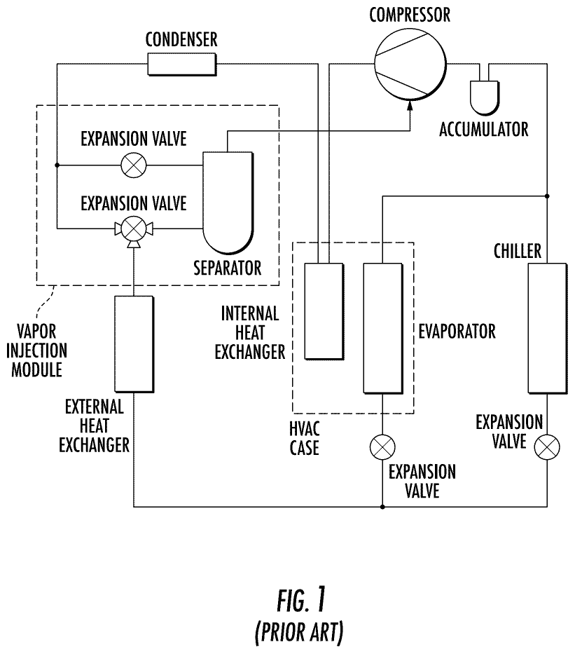

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

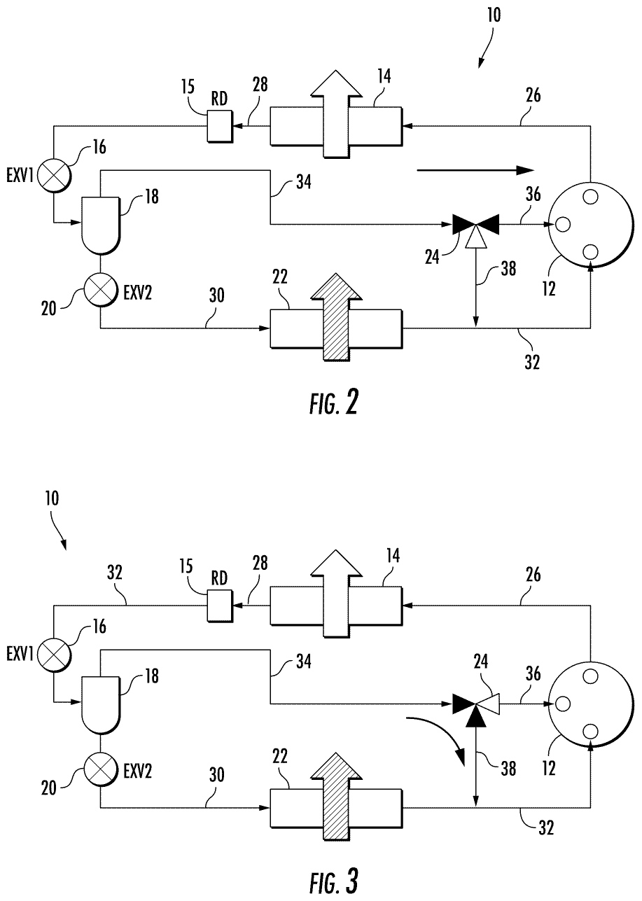

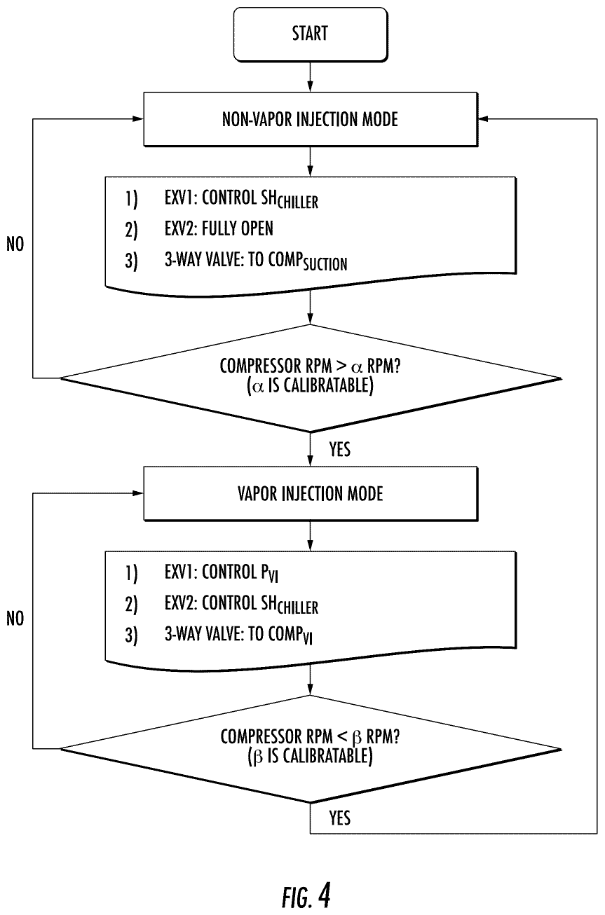

FIGS. 2 and 3 schematically illustrate an embodiment of a refrigerant circuit 10 of a heat pump system according to the present disclosure. The refrigerant circuit 10 may be a closed-loop system that allows heat to be transferred using a refrigerant flowing therethrough. The refrigerant circuit 10 is shown in substantially simplified schematic form in FIGS. 2 and 3 may include additional flow paths, valves, and/or components from those illustrated without necessarily departing from the scope of the present disclosure, so long as the same relationships are present within the refrigerant circuit 10 for prescribing operation thereof in the manner described hereinafter.

The refrigerant circuit 10 of the heat pump system may form a portion of a larger and more complex thermal management system. An exemplary heat pump system comprises the refrigerant circuit 10 and/or a coolant circuit (not depicted). The refrigerant circuit 10 may be in heat exchange communication with the coolant circuit. The heat pump system may be incorporated in a vehicle, such as a hybrid or electric vehicle relying upon stored electrical power to provide heating and cooling to various components of the vehicle as well as the air to be delivered to the passenger compartment (also referred to herein as “cabin”) of the vehicle via the operation of the heat pump system including the refrigerant circuit 10 and/or the coolant circuit. The refrigerant circuit 10 may also be in heat exchange communication or fluid communication with additional components or systems of the associated vehicle in order to heat and/or cool such components or systems. For example, additional heat exchangers may be in fluid communication with the refrigerant of the refrigerant circuit 10, wherein these heat exchangers may be provided as evaporators or chillers for cooling a battery of the vehicle, heat generating electronic components of the vehicle, or the like. Such evaporators or chillers may be in fluid and/or heat exchange communication with one or more secondary refrigerants or coolants associated with such secondary systems. In other circumstances, such heat exchangers may be provided to heat such electronic components from a cold initial state in order for such electronic components to operate most efficiently, or to potentially evaporate or thaw water or ice accumulated on such components. It is understood that the refrigerant circuit 10 may be utilized in any vehicular application without necessarily departing from the scope of the present disclosure.

As provided in FIGS. 2 and 3, the refrigerant circuit 10 includes a vapor injection compressor 12 having a suction side, a discharge side, and an injection side, a heat exchanger 14 (also referred to herein as “condenser”), an expansion element 16 (e.g., an expansion valve (EXV1)), a liquid-gas separator 18, an expansion element 20 (e.g., an expansion valve (EXV2)), a heat exchanger 22 (also referred to herein as “chiller (or evaporator)”), and a flow control member 24 (e.g., a three-way valve). The heat exchanger 22 may be configured as a chiller, or alternatively, as an evaporator, of the refrigerant circuit 10. In certain embodiments, the condenser 14 and/or the chiller 22 may be disposed inside a heating, ventilation, and air-conditioning (HVAC) case of the vehicle for selective heat exchange relationship with air to be delivered to the cabin. That is, the heat exchanger 22 may be disposed within the HVAC case to be selectively passed by the refrigerant to cool the air to be delivered to the passenger cabin based on the selection of an air-conditioning mode of operation by a passenger of the vehicle. Accordingly, the refrigerant absorbs heat from the ambient air before returning to the suction side of the compressor 12 as a relatively low-temperature and low-pressure gas.

A fluid line 26 fluidly connects the compressor 12 to the condenser 14, a fluid line 28 fluidly connects the condenser 14 to the separator 18, a fluid line 30 fluidly connects the separator 18 to the chiller (or evaporator) 22, a fluid line 32 (i.e., a suction fluid line) fluidly connects the separator 18 to the suction side of the compressor 12, a fluid line 34 fluidly connects the separator 18 to the flow control member 24, a fluid line 36 (i.e., an injection fluid line) fluidly connects the flow control member 24 to the injection side of the compressor 12, and a fluid line 38 fluidly connects the flow control member 24 to the fluid line 32 (i.e., the suction fluid line). Optionally, a receiver-drier (RD) 15 may be disposed in the fluid line 28 between the condenser 14 and the expansion element 16. As illustrated, the expansion element 16 is located downstream of the condenser 14 and upstream of the separator 28 in the fluid line 28 and the expansion element 20 is located downstream of the separator 18 and upstream of the chiller (or evaporator) 22 in the fluid line 30.

The compressor 12 may be any compressor configured to compress the refrigerant of the refrigerant circuit 10 when in a relatively low-pressure, gaseous phase to increase the temperature and pressure of the refrigerant when passing through the compressor 12. The refrigerant accordingly is discharged from the compressor 12 as a relatively high-temperature, high-pressure gaseous phase.

The condenser 14 is a heat exchanger configured to remove heat from the relatively high-temperature, high-pressure refrigerant exiting the compressor 12. The relatively high-pressure refrigerant exiting the condenser 14 may be partially liquid and partially gaseous in phase. The condenser 14 may be a heating heat exchanger disposed in an ambient environment or within the HVAC case of the vehicle and may be configured to heat air delivered to the cabin of the vehicle. A temperature door may be disposed in the HVAC case to selectively control the flow of the air through the condenser 14 during various operating modes of the refrigerant circuit 10.

In some embodiments, the RD 15 acts as a reservoir for the refrigerant exiting the condenser 14. It may also remove any water vapor from the refrigerant, ensuring that only liquid refrigerant reaches the expansion elements 16, 20, as well as traps undesirable particles and contaminants that could damage other components of the refrigerant circuit 10.

The expansion element 16 may refer to any structure or device for contracting and then expanding the flow of the refrigerant therethrough such that a temperature and a pressure of the refrigerant are each lowered following passage therethrough. The expansion element 16 is accordingly configured to lower the temperature and the pressure of the refrigerant passing therethrough prior to entry into the separator 18. It should be appreciated that the expansion element 16 may be an adjustable expansion device wherein a cross-section flow through the expansion element 16 may be varied to alter the drop in pressure and temperature of the refrigerant passing therethrough, as is necessary. For example, the expansion element 16 may be selectively positionable between a fully open position, a fully closed position, and a plurality of intermediate positions between the fully open and fully closed positions (e.g., CONTROL P_{VI}, CONTROL SH_{CHILLER}). If utilized, the varying of the flow cross-section through the expansion element 16 may be active, as desired. Accordingly, the expansion element 16 may be configured to selectively control or regulate the refrigerant flow, and thereby a vapor injection pressure at the compressor 12.

The separator 18 divides the refrigerant into a vapor phase and a separate liquid phase. As such, the separator 18 protects the compressor 12 by ensuring that only vapor enters the injection side of the compressor 12, thereby preventing liquid slugging, which can cause mechanical damage to the compressor 12.

Similar to the expansion element 16, the expansion element 20 may refer to any structure or device for contracting and then expanding a flow of the refrigerant therethrough such that a temperature and a pressure of the refrigerant are each lowered following passage therethrough. The expansion element 20 is accordingly configured to lower the temperature and the pressure of the liquid refrigerant from the separator 18 passing therethrough prior to entry into the chiller (or evaporator) 22. It should be appreciated that the expansion element 20 may be an adjustable expansion device wherein a flow cross-section through the expansion element 20 may be varied to alter the drop in pressure and temperature of the refrigerant passing therethrough, as is necessary. For example, the expansion element 20 may be selectively positionable between a fully open position, a fully closed position, and a plurality of intermediate positions between the fully open and fully closed positions (e.g., CONTROL SH_{CHILLER}). If utilized, the varying of the flow cross-section through the expansion element 20 may be active, as desired. Accordingly, the expansion element 20 may be configured to selectively control or regulate the refrigerant flow to and distribution within the chiller (or evaporator) 22.

The chiller (or evaporator) 22 is a heat exchanger configured to add heat to the relatively low-temperature, low-pressure refrigerant prior to entering the suction side of the compressor 12. The refrigerant exiting the chiller (or evaporator) 22 may be gaseous in phase or may be a combination of gaseous and liquid in phase. The chiller (or evaporator) 22 may also be in fluid and heat exchange communication with the coolant circuit by absorbing heat from the coolant originating from the coolant circuit. The coolant may be a liquid coolant, such as water, utilized in exchanging heat with at least one heat generating component in direct or indirect heat exchange communication with the coolant circuit. For example, the at least one heat generating component may refer to a battery of the vehicle, an electric motor of the vehicle, or to a heat generating electrical component associated with the operation of the vehicle, the heat pump system, and/or the thermal management system. In some embodiments, the chiller (or evaporator) 22 may be disposed in an ambient environment or within the HVAC case to cool the air to be delivered to the cabin based on the selection of an air-conditioning mode of operation by a passenger of the vehicle. The coolant circuit may be configured to provide the coolant to the chiller (or evaporator) 22 at a temperature greater than the temperature of the refrigerant within the chiller (or evaporator) 22 to ensure that the refrigerant is heated within the chiller (or evaporator) 22 during various operating modes of the heat pump system.

In some embodiments, the flow control member 24 selectively permits at least a portion of the vapor refrigerant discharged from the separator 18 to flow to the compressor 12. The flow control member 24 is independently and selectively positionable between a vapor injection or first position (COMP_{VI}), shown in FIG. 2, for a vapor injection operating mode and a suction or second position (COMP_{SUCTION}), shown in FIG. 3, for a non-vapor injection operating mode. In the first position, the flow control member 24 selectively permits at least a portion of the vapor refrigerant to flow through the fluid line 36 directly into the injection side of the compressor 12 (as depicted in FIG. 2). Contrarily, in the second position, the flow control member 24 selectively permits at least a portion of the vapor refrigerant to flow through the fluid lines 38, 32 prior to entering the suction side of the compressor 12 (as depicted in FIG. 3). As a result, the flow control member 24 independently and selectively controls the flow of the vapor refrigerant from the separator 18 during various operating modes of the refrigerant circuit 10 as described in greater detail hereinafter.

The refrigerant circuit 10 and/or the heat pump system may further include any combination of one or more sensors to monitor the characteristics and parameter thereof, for example, a speed (e.g., revolutions per minute (RPM)) of the compressor 12, the temperature and/or the pressure of the refrigerant entering the suction side of the compressor 12, the temperature and/or the pressure of the refrigerant entering the injection side of the compressor 12, the temperature and/or the pressure of the refrigerant discharged from the discharge side of the compressor 12, and/or the temperature of the air delivered to the cabin of the vehicle. The one or more sensors may be operatively connected to and in electronic communication with at least one controller for the refrigerant circuit 10 and/or the heat pump system. The controller may be configured to monitor, regulate, and optimize the performance of the refrigerant circuit 10 and/or the heat pump system by continuously and/or periodically receiving data from the one or more sensors. In some embodiments, the controller is configured to use the sensed data to execute algorithms and adjust components such as increase and decrease the speed of the compressor 12, selectively control the position of the expansion elements 16, 20, and the like, for example.

Referring to FIG. 2, when the flow control member 24 is in the first position (COMP_{VI}), the refrigerant circuit 10 may be configured to operate in the vapor injection mode of operation. During the vapor injection mode, the refrigerant is compressed and heated within the compressor 12 before being discharged and flowing into the condenser 14. Inside the condenser 14, the relatively high-temperature, high-pressure refrigerant discharged from the compressor 12 transfers heat to the ambient air or the air passing through the HVAC case to the cabin, while substantially simultaneously cooling and condensing the refrigerant. After flowing through the condenser 14, the relatively high-pressure condensed refrigerant then flows through the RD 15, if present, where any water vapor and undesired particles and contaminants are removed from the refrigerant.

After passing through the condenser 14 and, if present, the RD 15, the relatively high-pressure condensed refrigerant flows to the expansion element 16, where both the temperature and pressure of the refrigerant are reduced and the refrigerant is expanded to a two-phase refrigerant before entering the separator 18. Inside the separator 18, the vapor phase of the two-phase refrigerant (i.e., the vapor refrigerant) is separated from the liquid phase of the two-phase refrigerant (i.e., the liquid refrigerant). Herein, it is understood that the “vapor refrigerant” may be comprised of only vapor refrigerant or substantially vapor refrigerant with a nominal amount of liquid refrigerant remaining after flowing through the separator 18 and the “liquid refrigerant” may be comprised of only liquid refrigerant or substantially liquid refrigerant with a nominal amount of vapor refrigerant remaining after flowing through the separator 18. The vapor refrigerant then flows through the flow control member 24 into the injection side of the compressor 12, while the liquid refrigerant flows to the expansion element 20. Accordingly, the expansion element 16 may be selectively positioned in a desired one of the intermediate positions (CONTROL P_{VI}) to control or regulate the refrigerant flow, and thereby the vapor refrigerant flow to control or regulate a vapor injection pressure at the injection side of the compressor 12. As the liquid refrigerant passes through the expansion element 20, both its temperature and pressure are further reduced, before entering the chiller (or evaporator) 22. In particular embodiments, the expansion element 20 may be selectively positioned in a desired one of the intermediate positions (CONTROL SH_{CHILLER}) to selectively control or regulate the refrigerant flow to and distribution within the chiller (or evaporator) 22.

Inside the chiller (or evaporator) 22, the refrigerant is in heat exchange relationship with the coolant of the coolant circuit, absorbing heat. In some instances, the chiller (or evaporator) 22 may be disposed within the HVAC case to cool the air to be delivered to the cabin during an air-conditioning mode of operation of the vehicle. The relatively low temperature, low-pressure gaseous refrigerant then flows from the chiller (or evaporator) 22 into the suction side of the compressor 12. As a result, the expansion element 20, when in the desired one of the intermediate positions (CONTROL SH_{CHILLER}), selectively controls or regulates a super heat of the refrigerant from the chiller (or evaporator) 22 flowing into the suction side of the compressor 12.

FIG. 3 illustrates the non-vapor injection operating mode with the flow control member 24 is in the second position (COMP_{SUCTION}). Preferably, the refrigerant circuit 10 may operate in the non-vapor injection mode during low load conditions (i.e., low refrigerant flow conditions). During the non-vapor injection mode, the refrigerant is compressed and heated within the compressor 12 before being discharged and flowing into the condenser 14. Inside the condenser 14, the relatively high-temperature, high-pressure refrigerant discharged from the compressor 12 transfers heat to the ambient air or the air passing through the HVAC case to the cabin, while substantially simultaneously cooling and condensing the refrigerant. After flowing through the condenser 14, the relatively high-pressure condensed refrigerant then flows through the RD 15, if present, where any water vapor and undesired particles and contaminants are removed from the refrigerant.

After passing through the condenser 14 and, if present, the RD 15, the relatively high-pressure condensed refrigerant flows to the expansion element 16, where both the temperature and pressure of the refrigerant are reduced and the refrigerant is expanded to a two-phase refrigerant before entering the separator 18. Accordingly, the expansion element 16 may be selectively positioned in a desired one of the intermediate positions (CONTROL SH_{CHILLER}). Inside the separator 18, the vapor refrigerant is separated from the liquid refrigerant. The vapor refrigerant then flows through the flow control member 24 and the fluid line 38 to combine with the relatively low-pressure vapor refrigerant from the chiller (or evaporator) 22 before entering the suction side of the compressor 12. Substantially simultaneously, the liquid refrigerant flows to the expansion element 20, which is in the fully open position. As such, the liquid refrigerant passes through the expansion element 20, where both its temperature and pressure remain unchanged, before entering the chiller (or evaporator) 22. Accordingly, only the liquid refrigerant is injected into the chiller (or evaporator) 22 to alleviate maldistribution and improve performance thereof. This occurs particularly under the low load conditions.

Inside the chiller (or evaporator) 22, the refrigerant is in heat exchange relationship with the coolant of the coolant circuit, absorbing heat. As described hereinabove, the chiller (or evaporator) 22 may be disposed within the HVAC case to cool the air to be delivered to the cabin during an air-conditioning mode of operation of the vehicle. The relatively low temperature, low-pressure gaseous refrigerant then flows from the chiller (or evaporator) 22, combines with the vapor refrigerant from the separator 18, and flows into the suction side of the compressor 12. Accordingly, the expansion element 16, when in the desired one of the intermediate positions (CONTROL SH_{CHILLER}), selectively controls or regulates the refrigerant flow to and distribution within the chiller (or evaporator) 22, and thereby also controls or regulates a super heat of the refrigerant flow from the chiller (or evaporator) 22 into the suction side of the compressor 12.

FIG. 4 includes a flow chart describing one exemplary set of conditions under which operation of the disclosed refrigerant circuit 10 may occur. In particular, the refrigerant circuit 10 of the heat pump system is governed by the at least one controller that is in electronic communication with the one or more sensors configured to detect and measure operational characteristics and parameters, including the compressor speed (RPM). Based on sensor input (e.g., the sensed compressor speed (RPM)), the at least one controller determines whether to switch the refrigerant circuit 10 from the non-vapor injection mode to the vapor injection mode, and vice versa. For example, the at least one controller may initiate the switch to vapor injection mode when the compressor 12 operates above or is great than a first threshold speed (α RPM) for a predetermined duration. Conversely, the at least one controller may command a switch back to the non-vapor injection mode when the compressor speed drops below or is less than a second threshold speed (β RPM) for a predetermined duration. The first and second threshold speeds are calibratable and may be the same or different depending on the specific application of the refrigerant circuit 10 and/or the heat pump system. The at least one controller may continuously monitor these parameters and repeat the decision-making process depicted in FIG. 4 throughout operation to dynamically optimize system performance and ensure efficient thermal regulation under varying operating conditions.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heat pump system, comprising:
a compressor configured to compress a refrigerant flow in the heat pump system;
one or more heat exchangers in fluid communication with the compressor;
a plurality of expansion elements in fluid communication with the heat exchangers, each of the expansion elements selectively positionable between a closed position, an open position, and one or more intermediate positions between the closed and open positions;
a separator disposed downstream of one of the expansion elements relative to the refrigerant flow through the heat pump system and upstream of another one of the expansion elements relative to the refrigerant flow through the heat pump system, the separator configured to separate the refrigerant flow into a vapor refrigerant flow and a liquid refrigerant flow; and
a flow control member disposed downstream of the separator relative to the refrigerant flow through the heat pump system, the flow control member selectively positionable between a first position and a second position, wherein the flow control member, in the first position, is configured to direct the vapor refrigerant flow to an injection side of the compressor when the heat pump system operates in a vapor injection mode, and wherein the flow control member, in the second position, is configured to direct the vapor refrigerant flow to a suction side of the compressor when the heat pump system operates in a non-vapor injection mode.

2. A heat pump system, comprising:
a compressor configured to compress a refrigerant flow in the heat pump system;
a first heat exchanger disposed downstream of the compressor relative to the refrigerant flow through the heat pump system;
a first expansion element disposed downstream of the first heat exchanger relative to the refrigerant flow through the heat pump system, the first expansion element selectively positionable between a closed position, an open position, and one or more intermediate positions between the closed and open positions;
a separator disposed downstream of the first expansion element relative to the refrigerant flow through the heat pump system and configured to separate the refrigerant flow into a vapor refrigerant flow and a liquid refrigerant flow;
a second expansion element disposed downstream of the separator relative to the refrigerant flow through the heat pump system, the second expansion element selectively positionable between a closed position, an open position, and one or more intermediate positions between the closed and open positions;
a second heat exchanger disposed downstream of the second expansion element relative to the refrigerant flow through the heat pump system; and
a flow control member disposed downstream of the separator relative to the refrigerant flow through the heat pump system, wherein the flow control member is selectively positionable to switch the heat pump system between a vapor injection mode and a non-vapor injection mode based on operational conditions of the heat pump system.

3. The heat pump system of claim 2, wherein the first heat exchanger is configured to perform as a condenser.

4. The heat pump system of claim 2, wherein the second heat exchanger is configured to perform as a chiller or an evaporator.

5. The heat pump system of claim 2, wherein the first expansion element is in a desired one of the intermediate positions when the heat pump system is in the non-vapor injection mode.

6. The heat pump system of claim 2, wherein the first expansion element is in a desired one of the intermediate positions when the heat pump system is in the vapor injection mode.

7. The heat pump system of claim 2, wherein the second expansion element is in a fully open position when the heat pump system is in the non-vapor injection mode.

8. The heat pump system of claim 2, wherein the second expansion element is in a desired one of the intermediate positions when the heat pump system is in the vapor injection mode.

9. The heat pump system of claim 2, wherein the separator is in fluid communication with an injection side and a suction side of the compressor.

10. The heat pump system of claim 2, wherein the flow control member, in a first position, is configured to direct the vapor refrigerant flow to an injection side of the compressor when the heat pump system operates in the vapor injection mode, and wherein the flow control member, in the second position, is configured to direct the vapor refrigerant flow to a suction side of the compressor when the heat pump system operates in the non-vapor injection mode.

11. A method of operating a heat pump system, comprising:
providing a heat pump system including:
a compressor configured to compress a refrigerant flow;
one or more heat exchangers in fluid communication with the compressor;
one or more expansion elements in fluid communication with the heat exchangers, each of the expansion elements selectively positionable between a closed position, an open position, and one or more intermediate positions between the closed and open positions;
a separator configured to separate the refrigerant flow into a vapor refrigerant flow and a liquid refrigerant flow; and
a flow control member selectively positionable between a first position and a second position; and
dynamically controlling a mode of operation of the heat pump system between a vapor injection mode and a non-vapor injection mode by selectively positioning the flow control member based on operational conditions of the heat pump system.

12. The method of claim 11, wherein the flow control member, in the first position, is configured to direct the vapor refrigerant flow to an injection side of the compressor when the heat pump system operates in the vapor injection mode.

13. The method of claim 11, wherein the flow control member, in the second position, is configured to direct the vapor refrigerant flow to a suction side of the compressor when the heat pump system operates in the non-vapor injection mode.

14. The method of claim 11, further comprising sensing a speed of the compressor to determine a sensed compressor speed.

15. The method of claim 14, further comprising comparing the sensed compressor speed to a first threshold speed for a predetermined duration.

16. The method of claim 15, wherein the first threshold speed is calibratable.

17. The method of claim 15, wherein the mode of operation of the heat pump system is switched from the non-vapor injection mode to the vapor injection mode when the sensed compressor speed is greater than the first threshold speed for the predetermined duration.

18. The method of claim 15, further comprising comparing the sensed compressor speed to a second threshold speed for a predetermined duration.

19. The method of claim 18, wherein the second threshold speed is calibratable.

20. The method of claim 18, wherein the mode of operation of the heat pump system is switched from the vapor injection mode to the non-vapor injection mode when the sensed compressor speed is less than the second threshold speed for the predetermined duration.
